(19) United States
(12) Patent Application Publication
(10) Pub. No.: US 2004/0217745 A1
(43) Pub. Date: Nov. 4, 2004

(54) Power regulator

(75) Inventor: Huan-Jan Hung, Hsinchu City (TW)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Winbond Electronics Corp., Hsinchu (TW)

(21) Appl. No.: 10/785,537

(22) Filed: Feb. 24, 2004

(30) Foreign Application Priority Data
Apr. 30, 2003 (TW) 92110219

(51) Int. Cl. G05F 1/40

(52) U.S. Cl. 323/282

(57) ABSTRACT

An improved power regulator is provided. The improved power regulator includes a linear control circuit having an output terminal electrically connected to an input terminal thereof for producing a reference voltage and a pulse width modulation circuit electrically connected to the linear control circuit in response to the reference voltage and an input voltage so as to produce an output voltage.

### FIELD OF THE INVENTION

The present invention relates to a power regulator, and more particularly to a power regulator using a pulse width modulation circuit.

### BACKGROUND OF THE INVENTION

The design for the power systems of the electronic products needs to base on the functionality and specification of the electronic systems. Therefore, the functions and the architectures of the power system are required to be improved constantly. Among the power systems, the linear regulator is the very common structure.

Please refer to FIG. 1, which is the block diagram of the circuit of a linear power regulator according to prior arts.. The prior linear power circuit includes a linear control circuit 11 and a power transistor 12. In the common and popular structure, an operational amplifier 111 (OP-Amp) implements the linear control circuit 11. The output terminal DRIVE of the operational amplifier 111 is electrically connected to the power transistor 12. While Metal Oxide Silicon Field Effect Transistor (MOSFET) (no shown) is used as the power transistor 12, the output terminal DRIVE is electrically connected to the gate of the MOSFET. Or while the Bipolar Junction Transistor (BJT) (no shown) is used as power transistor 12, the output terminal DRIVE is electrically connected to the base of the Bipolar Junction Transistor (BJT) to drive the power transistor 12. Also the power transistor 12 receives an input voltage Vin and one of the output terminals of the power transistor 12 is electrically connected to the invert input terminal SENSE of the operational amplifier 111 to send the voltage variation of the output terminal to the operational amplifier 111. The operational amplifier 111 will compare the voltage difference of the output terminal with the reference voltage Vref and then provide a compensation signal to drive the power transistor 12 for keeping the output voltage Vout stable.

The disadvantage of the prior linear power regulator is that when the big voltage different appears between Vin and Vout, lots of power is dissipated on the power transistor 12. This causes the high temperature on the power transistor 12 and results in the voltage source of output terminal being incapable of providing the large current. Such circuit limits the applications of the linear power regulator.

Because of the technical defects described above, the applicant keeps on carving unflaggingly to develop “power regulator” through wholehearted experience and research.

### SUMMARY OF THE INVENTION

It is an object of the present invention to provide an improved power regulator. A pulse width modulation circuit is serially connected to the output terminal of prior linear control circuit for improving the efficiency of the power switching and also increasing the capability of providing larger output current of the output terminal.

It is another object of the present invention to provide an improved power regulator. In order to eliminate the disadvantage of the big voltage difference between Vin and Vout causing lots of power dissipated on the power transistor, an improved power regulator is provided. Without changing the original architecture, a pulse width modulation circuit is serially connected to the output terminal of the linear control circuit to increase the capability of power supply of the output terminal voltage source.

It is the other object of the present invention to provide an improved power regulator for eliminating the disadvantage of the decreased rating resulted from the temperature effect of the power transistor.

In accordance with an aspect of the present invention is to provide an improved power regulator, including a linear control circuit having an output terminal electrically connected to an input terminal thereof for producing a reference voltage and a pulse width modulation circuit electrically connected to the linear control circuit in response to the reference voltage and an input voltage so as to produce an output voltage.

Preferably, the linear control circuit is an operational amplifier.

Preferably, the output terminal of the operational amplifier is electrically connected to an inverting input terminal thereof.

Preferably, the pulse width modulation circuit is a synchronous pulse width modulation circuit.

Preferably, the pulse width modulation circuit is an asynchronous pulse width modulation circuit.

### BRIEF DESCRIPTION OF THE DRAWINGS

FIGS. 1 is a block diagram of the circuit of a linear power regulator according to prior arts; and

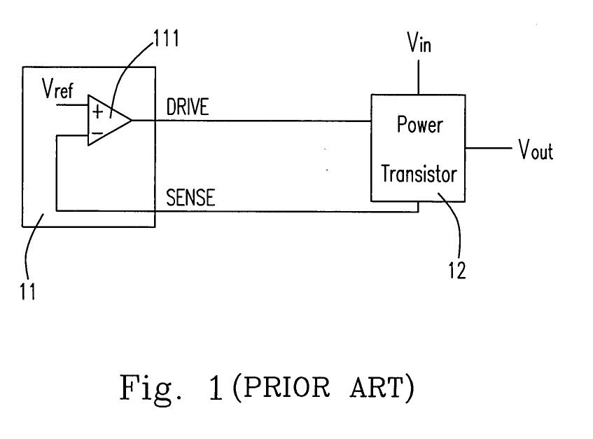

FIGS. 2 is a block diagram of the circuit of a linear power regulator according to a preferred embodiment of the present invention.

### DETAILED DESCRIPTION OF THE PREFERRED EMBODIMENT

In order to eliminate the disadvantage of being incapable of supplying large current from the voltage source of the output terminal of the prior linear regulator, the present invention is to provide an improved power regulator. Without changing the original architecture, a pulse width modulation circuit is serially connected to the output terminal of the linear control circuit to increase the capability of power supply of the output terminal voltage source.

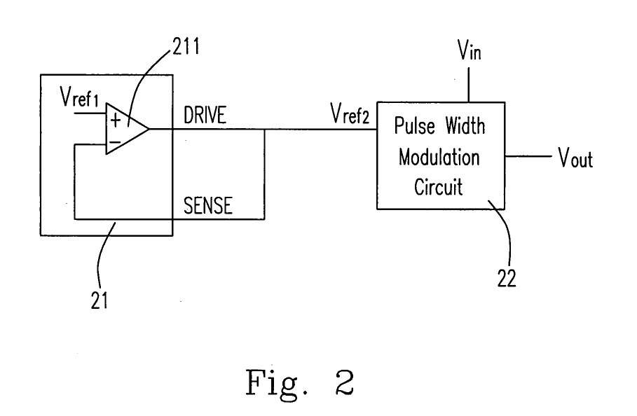

Please refer to FIG. 2, which is a block diagram of the circuit of the power regulator according to a preferred embodiment of the present invention. The power regulator includes a linear control circuit 21 and a pulse width modulation circuit 22. The linear control circuit 21 is implemented by an operational amplifier 211. The output terminal DRIVE of the operational amplifier 211 is electrically connected to the inverted input terminal SENSE of the operational amplifier 211 to output a second reference voltage Vref2 for responding to a first reference voltage Vref1. The pulse width modulation circuit 22 is electrically connected to the linear control circuit 21 to produce an output voltage Vout for responding to the second reference voltage Vref2 and an input voltage Vin so as to generate the power.

According to the improved power regulator of the present invention, the linear control circuit 21 is only used to serve as a control circuit for providing the reference voltage (the second reference voltage, Vref2) for the pulse width modulation circuit 22 and is not responsible for supplying the power. Therefore, the DRIVE terminal can be directly connected to the SENSE terminal. The pulse width modulation circuit 22 then refers the second reference voltage Vref2 to supply the power. This way will improve the efficiency when the power is switching and also increase the capability of providing larger output current.

The pulse width modulation circuit 22 described above can be either a synchronous pulse width modulation circuit or an asynchronous pulse width modulation circuit. While the voltage switching rate is higher, the synchronous pulse width modulation circuit is suggested because of the higher switching efficiency.

According to the improved power regulator of the present invention, the linear control circuit 21 is only used to serve as a control circuit for providing the reference voltage (the second reference voltage, Vref2) for the pulse width modulation circuit 22 and is not responsible for supplying the power. Therefore, the DRIVE terminal can be directly connected to the SENSE terminal. The pulse width modulation circuit 22 then refers the second reference voltage Vref2 to supply the power. This way will improve the efficiency when the power is switching and also increase the capability of providing larger output current.

To sum up the above, the present invention is to provide an improved linear control regulator. A pulse width modulation circuit is serially connected to the output terminal of the original linear control circuit for improving the efficiency when the power is switching and also increasing the capability of current supply of the output terminal. The present invention effectively eliminates the disadvantages of the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power regulator, comprising:
a linear control circuit having an output terminal electrically connected to an input terminal thereof for producing a reference voltage; and
a pulse width modulation circuit electrically connected to said linear control circuit in response to said reference voltage and an input voltage so as to produce an output voltage.

2. The power regulator as claimed in claim 1, wherein said linear control circuit is an operational amplifier.

3. The power regulator as claimed in claim 2, wherein said output terminal of said operational amplifier is electrically connected to an inverting input terminal thereof.

4. The power regulator as claimed in claim 1, wherein said pulse width modulation circuit is a synchronous pulse-width-modulation circuit.

5. The power regulator as claimed in claim 1, wherein said pulse width modulation circuit is an asynchronous pulse-width-modulation circuit.
